(19) United States
(12) Patent Application Publication
(10) Pub. No.: US 2025/0226197 A1
(43) Pub. Date: Jul. 10, 2025

(54) ANALYZER

(71) Applicant: HITACHI HIGH-TECH CORPORATION, Tokyo (JP)

(72) Inventor: Kouji ISHIGURO, Tokyo (JP)

(73) Assignee: HITACHI HIGH-TECH CORPORATION, Tokyo (JP)

(21) Appl. No.: 18/850,757

(22) PCT Filed: Mar. 31, 2022
(86) PCT No.: PCT/JP2022/016938

§ 371 Date: Sep. 25, 2024

(51) Int. Cl. H01J 49/04; H01J 49/16; H01J 49/24; H01J 49/42

(52) U.S. Cl. CPC H01J 49/0495; H01J 49/167; H01J 49/24; H01J 49/421

(57) ABSTRACT

The present invention provides an analyzing device with which an inflow volume of a gas into a vacuum pump when a power supply to the vacuum pump is stopped can be reduced by means of a simple construction. This analyzing device comprises a charged particle generation source for generating charged particles, vacuum chambers having an evacuated interior, a fine hole for introducing the charged particles from the charged particle generation source into the vacuum chamber, and vacuum pumps connected to the vacuum chambers, wherein the analyzing device is provided with a sealing plug capable of sealing the fine hole, and the sealing plug seals the fine hole when conduction of electricity to the vacuum pump stops.

### TECHNICAL FIELD

The present invention relates to an analyzer such as a mass spectrometer.

### BACKGROUND ART

The mass spectrometer includes an ion source that ionizes a sample, a separation unit that separates ions according to the mass, and a measurement unit that measures the separated ions. A component in a sample is ionized into ions that can be electromagnetically separated, and the ions are introduced into the separation unit. The separation unit is configured in a vacuum chamber to ensure an ion range and separates ions according to a mass-to-charge ratio. In the measurement unit, the intensity of the ions separated according to the mass is detected using an electron multiplier.

The vacuum chamber is divided into a plurality of rooms and is differentially evacuated for each of the rooms. The front-stage vacuum chamber accommodates the separation unit and is connected to a dry roughing pump. The rear-stage vacuum chamber accommodates the separation unit or the measurement unit and is connected to a main turbomolecular pump. An iontophoresis electrode is provided between a container accommodating the ion source and the vacuum chamber.

In the iontophoresis electrode, a counter plate that generates an electric field is provided on the side of the container accommodating the ion source. In addition, a pore through which the container accommodating the ion source and the vacuum chamber communicate with each other penetrates the iontophoresis electrode. The ions generated from the sample by the ion source are introduced into the vacuum chamber through the pore due to a potential difference between the ion source and the counter plate or due to a pressure difference between the container accommodating the ion source and the vacuum chamber.

Recently, further improvement of the sensitivity of the mass spectrometer has been required. The sensitivity of the detection of the ions is improved when the introduction amount of ions into the measurement unit accommodated in the vacuum chamber increases. However, in the related art, the pore formed in the iontophoresis electrode has high flow path resistance. By increasing the hole diameter of the pore, the flow path resistance is reduced, and thus an increase in the introduction amount of ions is expected. It should be noted that, when the hole diameter of the pore increases, the inflow amount of gas also increases, and thus the vacuum degree of the vacuum chamber decreases.

In order to improve the sensitivity of the detection of the ions, it is necessary to maintain a high vacuum degree of the vacuum chamber. The high vacuum degree can be implemented by a vacuum pump having a high exhaust rate. However, the vacuum pump having a high exhaust rate is a large device and requires a high device cost. Recently, in order to solve the problem, a countermeasure of increasing the hole diameter of the pore and increasing the number of vacuum pumps is taken.

In the mass spectrometer, when blackout occurs in a power supply system, there is a problem in that power feeding to a vacuum pump stops. When power feeding to the vacuum pump stops, the differential evacuation is disabled, the roughing pump stops, and an excessive pressure is applied to the main pump. The stop of power feeding to the vacuum pump leads to damage of the vacuum pump, and thus a countermeasure for protecting the vacuum system is adopted.

PTL 1 discloses a vacuum pump isolation valve including a pilot valve. When a backing pump starts, the pilot valve is closed, and the vacuum pump isolation valve is blocked from the discharge/exhaust side of the backing pump (refer to paragraph 0030). On the other hand, when the power of the backing pump is lost, the pilot valve is opened, and the vacuum pump isolation valve is exposed to the discharge/exhaust side of the backing pump (refer to paragraph 0031).

PTL 2 discloses an atmospheric pressure ionization mass spectrometer where a leak valve is provided in an intermediate pressure portion. When a vacuum pump that evacuates the intermediate pressure portion and a vacuum pump that evacuates an analyzing unit stop, the leak valve is opened, and inert gas is introduced into the intermediate pressure portion. The leak valve is provided instead of a vacuum holding valve provided in a second porous electrode portion or a butterfly valve provided in an upper portion of a turbomolecular pump.

PTL 3 discloses a vacuum apparatus including a valve that is opened and closed by interlocking to prevent breakage of a vacuum pump. In the vacuum apparatus, a turbomolecular pump is protected by hardware interlocking of instantaneously closing valves on the exhaust side and the aspiration side when a dry pump stops during rotation of the turbomolecular pump.

PTL 4 discloses an exhaust apparatus including a turbomolecular pump and a motor-operated valve. In this exhaust apparatus, a motor-operated valve provided between a roughing pump and an exhaust port of a turbomolecular pump and a motor-operated valve provided between the turbomolecular pump and a chamber are closed when blackout occurs.

### CITATION LIST

### Patent Literature

PTL 1: JP2018-066370A
PTL 2: JPH06-068843A
PTL 3: JPH08-026857A
PTL 4: JP2002-147386A

### SUMMARY OF INVENTION

### Technical Problem

When blackout occurs in a power supply system of an analyzer, power feeding to a vacuum pump stops, and driving by power cannot be performed. However, a blade of the vacuum pump continues to rotate for a while by inertia. Until the blade stops, gas continuously flows into the aspiration side of the vacuum pump. The pressure on the aspiration side of the vacuum pump increases, and an excessive pressure is applied to the blade of the vacuum pump. Therefore, there is a problem in that the vacuum pump is damaged. The lifetime of the vacuum pump may decrease, or the blade of the vacuum pump may be broken or fractured.

In particular, when the driving of the blade is stopped, a turbomolecular pump used as the vacuum pump stops after gradually slowing down from the full rotation at several ten thousands of rpm and continuing to rotate for several tens of minutes. The turbomolecular pump is limited in working pressure range and is generally used in combination with a roughing vacuum pump. When blackout occurs, exhaust on the exhaust side of the turbomolecular pump by the roughing vacuum pump also stops. Therefore, a load on the blade of the vacuum pump increases.

Recently, in the field of a mass spectrometer or the like, in order to improve the sensitivity of the detection of ions, there is a tendency to increase the hole diameter of the pore through which the container accommodating the ion source and the vacuum chamber communicate with each other. When the hole diameter of the pore increases, the introduction amount of ions into the vacuum chamber increases. However, the inflow rate or inflow amount of gas flowing into the aspiration side of the vacuum pump when blackout occurs also increases. It is assumed that, since an excessive pressure is applied to the blade of the vacuum pump, the vacuum pump is highly likely to be damaged.

In general, the probability of the damage of the vacuum pump by blackout is not that high. However, once the vacuum pump is damaged, replacement is necessary, and enormous device cost is required. In general, as a countermeasure against blackout, the use of an uninterruptible power supply device is also considered. However, when the uninterruptible power supply device is added, the entire size of the analyzer increases, and the facility cost also increases. Therefore, in order to protect the vacuum pump of the analyzer when blackout occurs, a countermeasure using a simple structure at a low cost is desired.

In the technique of PTL 1, a pressure difference occurs from the pilot valve as a boundary, and thus there is a possibility that a rapid decrease in the vacuum degree of the vacuum chamber can be reduced. However, the pilot valve is provided between the backing pump and the vacuum pump. In this structure, the flow path resistance increases due to the pilot valve. Therefore, the exhaust rate of the vacuum pump slows down, and the vacuum degree of the vacuum chamber decreases. When a high vacuum degree is required, a vacuum pump having a high exhaust rate is required, and the entire size of the device increases, and the facility cost also increases.

In the technique of PTL 2, a decrease in the gain of a multiplier or the like that is an ion detector can be prevented. However, when the vacuum holding valve is provided in the second porous electrode portion, not only a problem of blockage of the pore of the second porous electrode by contamination or a problem of cost but also a problem of disturbance of an electric field occur. In addition, the problem of the blockage of the pore is likely to occur due to peeling of the contamination caused by the operation of the vacuum holding valve. Maintenance work for removing the contamination is required, which interrupts the work of the mass spectrometry. When the disturbance of an electric field occurs, there is an influence on the trajectory of charged particles, and the ionic permeability in the separation unit may decrease. On the other hand, when the butterfly valve is provided in the upper portion of the turbomolecular pump, the problem of the device cost occurs. In a typical exhaust sequence, the roughing vacuum pump can also reduce a load on the main turbomolecular pump. Therefore, with the countermeasure of providing the butterfly valve against blackout, there is a problem in cost performance.

In the technique of PTL 3, the valve that is opened and closed by interlocking is provided on the aspiration side and the exhaust side of the turbomolecular pump. However, in general, a pipe on the aspiration side or the exhaust side of the turbomolecular pump is provided with a relatively large inner diameter. In consideration of the exhaust rate of the turbomolecular pump, when a valve is provided at the portion, an increase in flow path resistance is not negligible. In a combined conductance of the valves, the effective exhaust rate decreases. In addition, a problem that the power consumption increases due to the operation of the valve itself or a problem that the entire size of the device increases occurs.

In the technique of PTL 4, the motor-operated valve is provided between the roughing pump and the exhaust port of the turbomolecular pump or between the turbomolecular pump and the chamber. However, when the motor-operated valve is provided on the aspiration side or the exhaust side of the turbomolecular pump as in PTL 3, the effective exhaust rate decreases. In addition, a problem that the power consumption increases due to the operation of the motor-operated valve itself or a problem that the entire size of the device increases occurs.

Accordingly, an object of the present invention is to provide an analyzer where the inflow amount of gas into a vacuum pump when power feeding to the vacuum pump stops can be reduced with a simple structure.

### Solution to Problem

In order to achieve the object, according to the present invention, there is provided an analyzer including: a charged particle generation source that generates charged particles; a vacuum chamber of which an inside is evacuated; a pore through which the charged particles are introduced into the vacuum chamber from the charged particle generation source; a vacuum pump that is connected to the vacuum chamber; and a sealing plug that is capable of sealing the pore, and in which when power application to the vacuum pump stops, the sealing plug seals the pore.

### Advantageous Effects of Invention

The present invention provides an analyzer where the inflow amount of gas into a vacuum pump when power feeding to the vacuum pump stops can be reduced with a simple structure.

### BRIEF DESCRIPTION OF DRAWINGS

FIG. 1 is a diagram illustrating a configuration of an analyzer according to an embodiment of the present invention.

FIG. 2A is a diagram illustrating an operation of a pressure type sealing plug in the analyzer.

FIG. 2B is a diagram illustrating the operation of the pressure type sealing plug in the analyzer.

FIG. 3 is a diagram illustrating a method of forming the plug hole in the analyzer.

FIG. 4 is a diagram illustrating a structure example of the plug hole in the analyzer.

FIG. 5 is a diagram illustrating the structure example of the plug hole in the analyzer.

FIG. 6 is a diagram illustrating the structure example of the plug hole in the analyzer.

FIG. 7A is a diagram illustrating an operation of an electromagnetic sealing plug in the analyzer.

FIG. 7B is a diagram illustrating the operation of the electromagnetic sealing plug in the analyzer.

### DESCRIPTION OF EMBODIMENTS

Hereinafter, an analyzer according to one embodiment of the present invention will be described with reference to the drawings. In the following each of the drawings, common configurations are represented by the same reference numerals, and the description thereof will not be repeated.

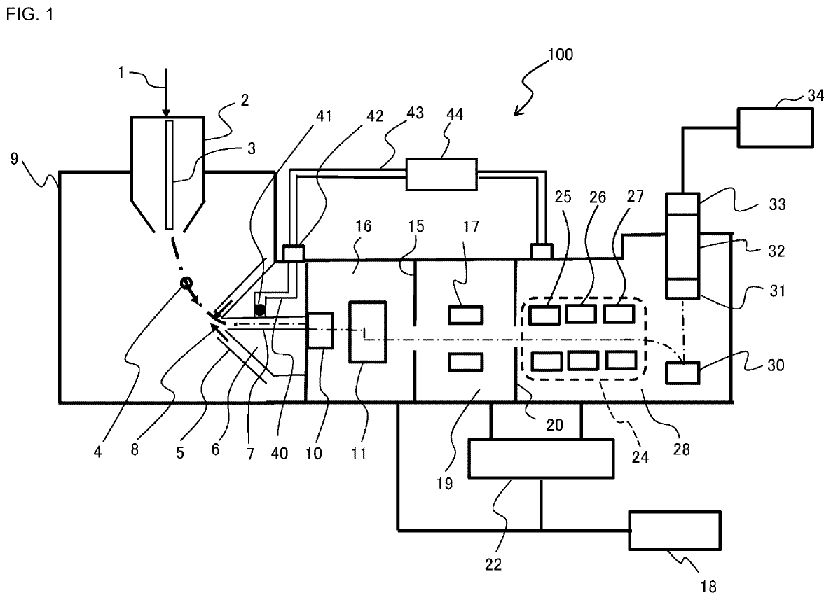

FIG. 1 is a diagram illustrating a configuration of an analyzer according to an embodiment of the present invention.

As illustrated in FIG. 1, an analyzer 100 according to the present embodiment includes an ion source (charged particle generation source) 2 that generates ions (charged particles), a vacuum chamber 16, 19, 28 of which the inside is evacuated, and a vacuum pump 18, 22. The analyzer 100 includes a sealing plug 41 that can seal a first pore 7 (introduction hole) through which ions generated from the ion source 2 are introduced from the ion source 2 into the vacuum chamber 16.

FIG. 1 illustrates a mass spectrometer including the ion source 2 using electrospray ionization (ESI) as the analyzer 100. In the analyzer 100, a component in a sample solution 1 is analyzed by mass spectrometry. As the sealing plug 41, a pressure type that operates due to a difference in air pressure and its own weight is provided.

The ion source 2 ionizes a sample in the sample solution 1 to generate ions. Ions 4 generated by the ion source 2 are emitted into an ion source container 9. The ion source 2 is fixed to the ion source container 9. The ion source container 9 is formed of, for example, metal such as an aluminum alloy or stainless steel. The ion source container 9 is in an atmospheric pressure atmosphere in the ESI.

The vacuum chamber 16, 19, 28 is divided into a plurality of rooms. In FIG. 1, the vacuum chamber 16, 19, 28 is configured with a first differential evacuation chamber 16, a second differential evacuation chamber 19, and an analysis chamber 28.

The ion source container 9 and the first differential evacuation chamber 16 are separated by an iontophoresis electrode 6. In the iontophoresis electrode 6, the first pore 7 penetrates the center thereof. The ion source container 9 and the first differential evacuation chamber 16 communicate with each other through the first pore 7.

The first differential evacuation chamber 16 and the second differential evacuation chamber 19 are separated by a first porous electrode 15. In the first porous electrode 15, a second pore penetrates the center thereof. The first differential evacuation chamber 16 and the second differential evacuation chamber 19 communicate with each other through the second pore.

The second differential evacuation chamber 19 and the analysis chamber 28 are separated by a second porous electrode 20. In the second porous electrode 20, a third pore penetrates the center thereof. The second differential evacuation chamber 19 and the analysis chamber 28 communicate with each other through the third pore.

The vacuum pump 18, 22 is connected to the vacuum chamber 16, 19, 28. An aspiration side of a turbomolecular pump 22 is connected to the second differential evacuation chamber 19 and the analysis chamber 28. An aspiration side of a dry pump 18 is connected to the first differential evacuation chamber 16 and an exhaust side of the turbomolecular pump 22. The turbomolecular pump 22 is a pump where a blade collides with gas molecules to hit the gas molecules for evacuation. At an air pressure at which the amount of the gas molecules is large, a high load is applied to the blade, and thus the exhaust side is evacuated by the dry pump 18.

The first differential evacuation chamber 16 accommodates an ion guide 11. The second differential evacuation chamber 19 accommodates an ion thermalizer 17. The analysis chamber 28 accommodates a mass filter 24. The ion guide 11, the ion thermalizer 17, and the mass filter 24 configure an ion analyzing unit that separates ions.

The analysis chamber 28 accommodates a conversion dynode 30, a scintillator 31, and a photomultiplier tube 32. The conversion dynode 30, the scintillator 31, and the photomultiplier tube 32 configure an ion detection unit that detects ions.

As the ion source 2, an ESI ion source that ionizes a sample by electrospray ionization (ESI) is provided. The ion source 2 includes a capillary 3, a sample introduction tube (not illustrated), a power supply, and the like. The sample introduction tube forms a path of the sample solution 1 from the outside of the ion source container 9 to the inside of the ion source 2. The capillary 3 forms a path of the sample solution 1 from the inside of the ion source 2 to the inside of the ion source container 9.

The capillary 3 sprays liquid droplets of the sample solution 1 into the ion source container 9. A tip portion of the capillary 3 is provided, for example, with an inner diameter of several tens to several hundreds of μm. The capillary 3 is electrically connected to a power supply (not illustrated). A positive voltage or a negative voltage of several kV is applied from the power supply to the capillary 3. The sample solution 1 is introduced into the sample introduction tube by a syringe pump (not illustrated) and enters the capillary 3. While being applied with a high voltage in the capillary 3, the sample solution 1 is sprayed into the ion source container 9.

In the ion source 2, a nebulizer tube (not illustrated) can be provided. The nebulizer tube can be disposed concentrically with the capillary 3 to surround the periphery of the capillary 3. The nebulizer tube sprays inert gas such as nitrogen gas or argon gas. When the sample solution 1 is sprayed from the capillary 3, in a case where the inert gas is sprayed from the nebulizer tube, the liquid droplets can be finely nebulized.

In the ion source 2, an auxiliary heating gas tube (not illustrated) can be provided. The auxiliary heating gas tube can be disposed concentrically with the nebulizer tube to surround the periphery of the nebulizer tube. The auxiliary heating gas tube sprays the heated inert gas such as nitrogen gas. When the sample solution 1 is sprayed from the capillary 3, in a case where the inert gas heated to several hundreds of ° C. by a heater (not illustrated) is sprayed from the auxiliary heating gas tube, the ionization or the miniaturization of the liquid droplets can be assisted.

The sample solution 1 is sprayed as liquid droplets from the tip portion of the capillary 3 into the ion source container 9. Regarding the liquid droplets of the sample solution 1, evaporation or collision of a solvent is promoted by the spraying of the inert gas. When the miniaturization of the liquid droplets progresses due to the evaporation or collision of the solvent, the size of an electric field on the surface of the liquid droplets increases. When the repulsive force between charges exceeds the surface tension of the liquid droplets, the liquid droplets break up. The sprayed liquid droplets are miniaturized while repeating the breakage, and the ions 4 on a single molecular level are finally generated.

In FIG. 1, as the ion source 2, an ESI ion source using electrospray ionization (ESI) is provided. In the ESI, positive and negative ions in a small amount of liquid can be detected. A polymer can be analyzed by mass spectrometry without fragmentation. It should be noted that a device using another ionization method may be provided as the ion source 2.

Examples of the other ionization method include atmospheric pressure chemical ionization (APCI), chemical ionization (CI), and electron impact (EI). As the ion source 2, an ECR (Electron Cyclotron Resonance) plasma ion source using a microwave, an ICP (Inductively Coupled Plasma) ion source, a Penning ion source, or a laser ion source may also be provided.

The iontophoresis electrode 6 is provided between the ion source container 9 and the first differential evacuation chamber 16. In the iontophoresis electrode 6, an upstream side is provided in a conical shape, and a downstream side is provided in a cylindrical shape. The first pore 7 is formed in the vicinity of a central axis of the iontophoresis electrode 6. The first pore 7 communicates with the ion source container 9 and the first differential evacuation chamber 16.

The upstream side of the iontophoresis electrode 6 is covered with a counter plate 5. The counter plate 5 is provided in a conical shape. In the counter plate 5, an opening having a diameter of several mm penetrates the center thereof. The opening of the counter plate 5 form a path of the ions 4 together with the first pore 7.

The counter plate 5 is electrically connected to a power supply (not illustrated). A positive voltage or a negative voltage is applied from the power supply to the counter plate 5. The nebulized gas generated by the ion source 2 includes the ions 4 that are ionized from the sample, neutral particles other than ions, liquid droplets of the sample solution 1 that are not vaporized. These components are introduced from the ion source container 9 into the first pore 7 due to an electric field formed between the capillary 3 and the counter plate 5 or a pressure difference between the ion source container 9 and the first differential evacuation chamber 16.

A gas flow path is formed between the counter plate 5 and the iontophoresis electrode 6. In the gas flow path, counter gas 8 flows from an inlet side of the first pore 7 to the inside of the ion source container 9. Examples of the counter gas 8 include inert gas such as nitrogen gas. By spraying the counter gas 8 in the opposite direction, the neutral particles other than ions or the liquid droplets of the sample solution 1 are prevented from penetrating into the first pore 7.

The counter plate 5 or the iontophoresis electrode 6 is heated to a high temperature by a heater (not illustrated). The counter plate 5 or the iontophoresis electrode 6 is heated to, for example, about 200° C. When the counter plate 5 or the iontophoresis electrode 6 is at the high temperature, liquid droplets of the sample solution 1 adjacent thereto are vaporized. The amount of the sample solution 1 attached to the counter plate 5 or the iontophoresis electrode 6 is reduced, and thus measurement error caused by carry-over of contamination can be reduced.

The ions 4 or the like generated from the ion source 2 are introduced due to an electric field or a pressure difference into the first differential evacuation chamber 16 through the first pore 7 and an axis-shifted portion 10 provided downstream of the first pore 7. The first pore 7 is provided, for example, as a through hole having a circular cross-section. The first pore 7 can be provided with a hole diameter of about 0.5 mm or more and 1.5 mm or less. The first pore 7 can be provided with a length of several tens of mm.

The axis-shifted portion 10 includes a pore that communicates with the first pore 7 and the first differential evacuation chamber 16. The central axis of the pore of the axis-shifted portion 10 is decentered from the central axis of the first pore 7. Due to decentering, a collision wall is formed at a position intersecting with the central axis of the first pore 7. The pore of the axis-shifted portion 10 is offset from the collision wall opened. According to the axis-shifted portion 10, a heavy component such as the liquid droplets of the sample solution 1 can be separated from a light component such as ions. The heavy component collides with the collision wall and cannot pass through the axis-shifted portion 10, whereas the light component passes through the axis-shifted portion 10 and can flow into the first differential evacuation chamber 16.

The first differential evacuation chamber 16 is evacuated by the dry pump 18. In the first differential evacuation chamber 16, a vacuum degree of approximately several hundreds of Pa is maintained during the operation of the dry pump 18. The first differential evacuation chamber 16 accommodates the ion guide 11.

The ion guide 11 is configured with a multipolar electrode or the like, and the ions 4 transmit through the ion guide 11 while being focused by the ion guide 11. The multipolar electrode is formed of a round bar of metal, ceramic, or the like. High frequency voltages having opposite polarities are applied to electrode rods adjacent to each other. The ions 4 pass through a space surrounded by the electrode rods and are focused by an electric field, and unnecessary components are removed.

Regarding the ion guide 11, for example, the upstream side can be configured with eight electrodes, and the downstream side can be configured with four electrodes. The central axis of the electrode group on the upstream side and the central axis of the electrode group on the downstream side can be decentered from each other in a direction orthogonal to a traveling direction of the ions. By providing an offset of approximately several mm, the neutral particles other than ions can be efficiently removed while allowing transmission of the predetermined ions 4.

The ions 4 or the like focused in the first differential evacuation chamber 16 are introduced into the second differential evacuation chamber 19 through the second pore due to an electric field or a pressure difference. The second pore is provided as a through hole that penetrates the first porous electrode 15 provided in a flat shape. The second pore can be provided with a hole diameter of several mm. The first porous electrode 15 can be provided with a thickness of several mm.

The second differential evacuation chamber 19 can be evacuated by the turbomolecular pump 22. The exhaust side of the turbomolecular pump 22 is evacuated by the dry pump 18. In the second differential evacuation chamber 19, a vacuum degree of approximately several Pa is maintained during the operation of the turbomolecular pump 22. The second differential evacuation chamber 19 accommodates the ion thermalizer 17.

The ion thermalizer 17 is configured with a multipolar electrode or the like, and the kinetic energy of the ions 4 are attenuated while the ions 4 are focused by the ion thermalizer 17. The multipolar electrode is formed of a round bar of metal, ceramic, or the like. High frequency voltages having opposite polarities are applied to electrode rods adjacent to each other. In addition, neutral gas such as helium or nitrogen is introduced. The ions 4 pass through a space surrounded by the electrode rods and are focused by an electric field while colliding with the neutral gas molecules. The kinetic energy of the ions 4 decreases due to the collision with the neutral gas molecules. Therefore, noise is reduced by spectral interference, and the sensitivity of a low-mass-number component is improved.

The ions 4 or the like focused in the second differential evacuation chamber 19 are introduced into the analysis chamber 28 through the third pore due to an electric field or a pressure difference. The third pore is provided as a through hole that penetrates the second porous electrode 20 provided in a flat shape. The third pore can be provided with a hole diameter of several mm. The second porous electrode 20 can be provided with a thickness of several mm.

The analysis chamber 28 can be evacuated by the turbomolecular pump 22. The exhaust side of the turbomolecular pump 22 is evacuated by the dry pump 18. In the analysis chamber 28, a vacuum degree of approximately 10⁻³ Pa is maintained during the operation of the turbomolecular pump 22. The analysis chamber 28 accommodates the mass filter 24, the conversion dynode 30, the scintillator 31, and the photomultiplier tube 32.

The mass filter 24 is configured with a first mass filter 25, a collision chamber 26, and a second mass filter 27. The first mass filter 25 and the second mass filter 27 are configured with a multipolar electrode, and a high frequency voltage or a DC voltage is controlled. The collision chamber 26 is configured with a cell accommodating the multipolar electrode, and neutral gas such as helium or nitrogen is introduced.

Under the control of the voltage, the first mass filter 25 transmits through only precursor ions having a specific mass-to-charge ratio (m/Z). The collision chamber 26 causes the precursor ions to collide with the neutral gas molecules. The precursor ions are cleaved at a portion having a weak chemical bond by collision-induced dissociation to dissociate the predetermined product ions. Under the control of the voltage, the second mass filter 27 transmits through only product ions having a specific mass-to-charge ratio (m/Z).

With the multiple mass filter 24, only the specific product ions dissociated from the precursor ions are separated. The influence of ions having an approximate mass other than the detection target can be excluded, and thus the product ions as the detection target can be quantitatively analyzed with high sensitivity. The product ions separated by the mass filter 24 are incident on the conversion dynode 30.

The conversion dynode 30 is configured with a secondary electron multiplier electrode. The secondary electron multiplier electrode is in a vacuum atmosphere and is applied with a high voltage having a polarity different from that of the detection target ions. When the ions collide with the secondary electron multiplier electrode, secondary electrons are generated. With the conversion dynode 30, the secondary electrons can be generated from the product ions with high efficiency.

The scintillator 31 converts electrons into light. The electrons generated from the conversion dynode 30 are converted into light by inverse photoemission spectroscopy using the scintillator 31. With the scintillator 31, the detection signal of the product ions is converted from the secondary electrons into light. By performing the light conversion, the influence of ions other than the detection target present inside the analysis chamber 28 can be reduced.

The photomultiplier tube 32 converts light into electrons and amplifies the electrons. The light converted by the scintillator 31 is converted into electrons by the photoelectric effect in the photomultiplier tube 32, and the electrons are amplified in a cascade manner by a plurality of electron multiplier electrodes. The analog signal of the amplified electrons is converted into a digital signal by an analog/digital converter 33.

The detection result of the ions detected by the ion detection unit is displayed on a monitor 34 as a mass spectrum or the like. The mass spectrum includes information regarding the mass-to-charge ratio (m/Z) of the ions separated from the sample solution 1, the detection intensity of the ions, and the like. By comparing the detection result of the ions to known data acquired in advance, qualitative analysis or quantitative analysis of a component in the sample solution 1 can be performed.

As illustrated in FIG. 1, in the iontophoresis electrode 6 of the analyzer 100 according to the present embodiment, a plug hole 40 is provided in the iontophoresis electrode 6 to be connected to an intermediate portion of the first pore 7. One end of the plug hole 40 is opened to the intermediate portion of the first pore 7. Another end of the plug hole 40 is opened to the upper portion of the iontophoresis electrode 6. The sealing plug 41 that can seal the first pore 7 is inserted into the plug hole 40.

The other end of the plug hole 40 is connected to a bypass pipe 43 through a vacuum joint 42 in the upper portion of the iontophoresis electrode 6. The other end of the bypass pipe 43 is connected to the analysis chamber 28 through the vacuum joint 42. As the bypass pipe 43, a resin pipe or a metal pipe where pressure resistance or flexibility is vacuum-compatible can be used. A vacuum valve 44 is provided in an intermediate portion of the bypass pipe 43.

The sealing plug 41 is a pressure type that is opened and closed due to its own weight and a pressure difference formed through the bypass pipe 43. The pressure difference is formed between the first pore 7 and the analysis chamber 28 through the bypass pipe 43. Irrespective of whether power is applied to the vacuum pump 18, 22, the first pore 7 is at an intermediate pressure between the ion source container 9 in the atmospheric pressure atmosphere and the first differential evacuation chamber 16. The analysis chamber 28 is maintained at the maximum vacuum degree in the vacuum chamber 16, 19, 28.

When power application to the vacuum pump 18, 22 is stopped during blackout, the sealing plug 41 falls from the inside of the plug hole 40 to the first pore 7 due to its own weight to close the first pore 7. On the other hand, when power is applied to the vacuum pump 18, 22, the sealing plug 41 floats from the first pore 7 to the inside of the plug hole 40 due to the pressure difference formed through the bypass pipe 43 to open the first pore 7.

When power application to the vacuum pump 18, 22 stops during blackout, driving of the vacuum pump 18, 22 by power stops. However, even when power application to the vacuum pump 18, 22 stops, the blade of the vacuum pump 18, 22 continues rotate for a while by inertia. The ion source container 9 is in the atmospheric pressure atmosphere, whereas the first differential evacuation chamber 16 is in a vacuum atmosphere. Therefore, while the blade of the vacuum pump 18, 22 is stopped, gas may flow into the first differential evacuation chamber 16 from the ion source container 9.

When gas may flow into the first differential evacuation chamber 16 from the ion source container 9, the pressure increases in order of the first differential evacuation chamber 16, the second differential evacuation chamber 19, and the analysis chamber 28. When the pressure of the first differential evacuation chamber 16, the second differential evacuation chamber 19, or the analysis chamber 28 increases, the aspiration side of the vacuum pump 18, 22 is at a high pressure. Since an excessive pressure is applied to the blade of the vacuum pump 18, 22, the vacuum pump 18, 22 may be damaged.

In particular, the turbomolecular pump 22 is limited in working pressure range and is used in combination with the dry roughing pump 18. The exhaust side of the turbomolecular pump 22 is evacuated by the dry pump 18. However, when blackout occurs, the evacuation by the dry pump 18 is also stopped. Therefore, a load on the blade of the turbomolecular pump 22 is likely to increase.

When a pressure increase rate of the aspiration side of the vacuum pump 18, 22 or a pressure difference between the aspiration side and the exhaust side of the vacuum pump 18, 22 exceeds a certain threshold, the blade is significantly damaged. The lifetime of the vacuum pump 18, 22 may decrease, or the blade of the vacuum pump 18, 22 may be broken or fractured. The vacuum pump 18, 22 needs to be replaced, and there is a problem in that enormous device cost is required. The problem of damage or cost is more significant in the turbomolecular pump 22 than in the dry pump 18.

On the other hand, by providing the sealing plug 41, when power application to the vacuum pump 18, 22 is stopped, the first pore 7 can be sealed without power. The inflow of gas from the ion source container 9 to the first differential evacuation chamber 16 can be significantly reduced. When power feeding to the vacuum pump 18, 22 stops, the inflow amount of gas into the vacuum pump 18, 22 can be reduced with a simple structure. Even when power application to the vacuum pump 18, 22 stops, a load on the blade can be reduced. Therefore, the damage to the vacuum pump 18, 22 can be reduced, and the lifetime can be extended.

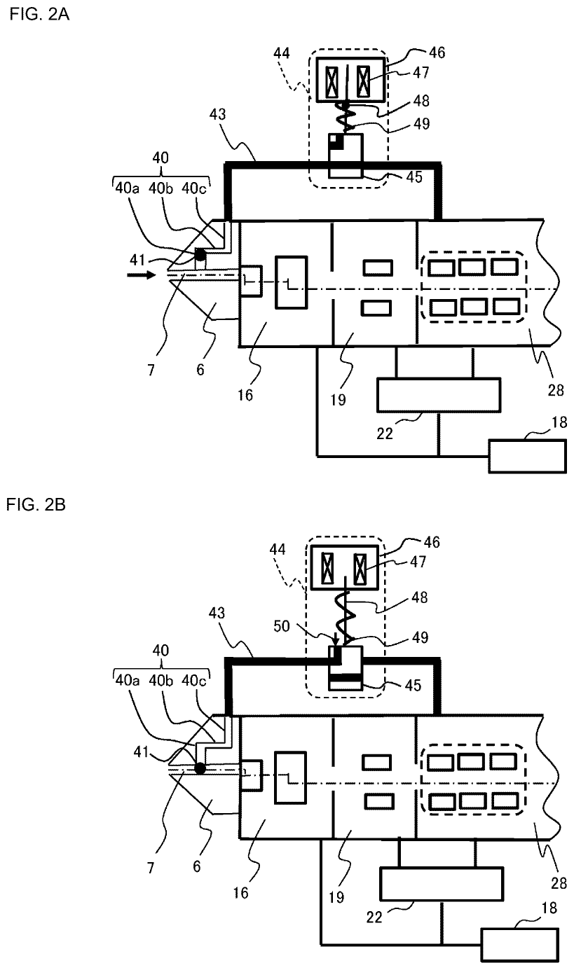

FIGS. 2A and 2B are diagrams illustrating an operation of the pressure type sealing plug in the analyzer. FIG. 2A illustrates a state of the vacuum pump 18, 22 during power application when power is fed to the analyzer 100. FIG. 2B illustrates a state of the vacuum pump 18, 22 during blackout when power feeding to the analyzer 100 stops.

As illustrated in FIGS. 2A and 2B, the pressure type sealing plug 41 can be configured to operate when the pressure difference formed through the bypass pipe 43 is switched by the vacuum valve 44.

It is preferable that the plug hole 40 is provided in a structure that is bent in an L-shape. In FIGS. 2A and 2B, the plug hole 40 includes a section 40a that extends upward from the intermediate portion of the first pore 7, a section 40b that extends in the horizontal direction at an intermediate height, and a section 40c that extends upward from the intermediate height. The section 40a and the section 40b communicate with each other at a portion that is bent in an L-shape. The section 40b and the section 40c communicate with each other at a portion that is bent in an inverted L-shape.

The hole diameter of the section 40a extending upward from the intermediate portion of the first pore 7 is the same as the outer diameter of the sealing plug 41. The hole diameter of the section 40b extending in the horizontal direction at an intermediate height is set to be less than the hole diameter of the section 40a extending upward from the intermediate portion of the first pore 7 or the outer diameter of the sealing plug 41. The hole diameter of the section 40c extending upward from the intermediate height is set not to interfere the passage of gas.

The sealing plug 41 is inserted into the section 40a extending upward from the intermediate portion of the first pore 7. In this structure, in the section 40a extending upward from the intermediate portion of the first pore 7, the sealing plug 41 can be moved up and down due to the pressure difference and its own weight. In the known structure and disposition of the iontophoresis electrode 6, the plug hole 40 can be opened to the intermediate portion of the first pore 7 while ensuring the connection of the bypass pipe 43 to the plug hole 40.

The vacuum valve 44 has a function of stopping power application to switch the flow path of the bypass pipe 43 when blackout occurs. The vacuum valve 44 includes a valve element 45, a coil housing 46, a solenoid coil 47, a movable magnetic member 48, and a spring 49.

The valve element 45 is movably provided, and includes a plurality of ports and a flow path through which the ports communicates with each other. The coil housing 46 accommodates the solenoid coil 47. The solenoid coil 47 is connected to a power supply (not illustrated), and generates an electromagnetic force by power application.

The movable magnetic member 48 has magnetism and is provided to be movable by the electromagnetic force. A tip of the movable magnetic member 48 supports the valve element 45. A base of the movable magnetic member 48 is inserted into the solenoid coil 47 to advance to and retreat from the inside of the solenoid coil 47. The spring 49 elastically links the valve element 45 and the coil housing 46 to each other. The spring 49 biases the valve element 45 toward the coil housing 46 such that the valve element 45 is at a communication position where the valve element 45 communicates with the bypass pipe 43.

The vacuum valve 44 is switchable between connection of the plug hole 40 and the analysis chamber 28 and connection of the plug hole 40 and a space in an atmospheric pressure environment in the flow path of the bypass pipe 43. In the valve element 46, two inlet ports and two outlet ports are provided.

One inlet port is switched to be opened to and closed from the section on the analysis chamber 28 side of the bypass pipe 43. The other inlet port is switched to be opened to and closed from the space in the atmospheric pressure environment. One outlet port communicates with the one inlet port in the valve element 45, and is switched to be opened to and closed from the section on the plug hole 40 side of the bypass pipe 43. The other outlet port communicates with the other inlet port in the valve element 45, and is switched to be opened to and closed from the section on the plug hole 40 side of the bypass pipe 43.

As illustrated in FIG. 2A, when power is fed to the analyzer 100, power is applied to the solenoid coil 47. The solenoid coil 47 generates an electromagnetic force by power application, and aspirates and pulls up the movable magnetic member 48 with the electromagnetic force. The valve element 45 supported by the movable magnetic member 48 is maintained at the communication position where the valve element 45 communicates with the bypass pipe 43 against the biasing of the spring 49.

At the communication position, the plug hole 40 and the analysis chamber 28 communicate with each other through the bypass pipe 43. When blackout occurs, the first pore 7 is at an intermediate pressure between the ion source container 9 and the first differential evacuation chamber 16. On the other hand, the analysis chamber 28 is maintained at a vacuum degree higher than that of the first differential evacuation chamber 16. Therefore, a portion of the plug hole 40 below the sealing plug 41 has a low vacuum degree close to the atmospheric pressure, and a portion of the plug hole 40 above the sealing plug 41 has a high vacuum degree.

When the valve element 45 is switched to the communication position, a large pressure difference is applied to both sides of the sealing plug 41. Therefore, the sealing plug 41 floats against its own weight due to the pressure difference, is held in the plug hole 40, and opens the first pore 7. The sealing plug 41 stops by colliding with an inner wall at the bent portion of the plug hole 40.

On the other hand, as illustrated in FIG. 2B, when power feeding to the analyzer 100 stops, power application to the solenoid coil 47 stops. The solenoid coil 47 does not generate an electromagnetic force and does not pull up the movable magnetic member 48. The valve element 45 supported by the movable magnetic member 48 is maintained at an opening position where the bypass pipe 43 is opened to the atmospheric pressure environment according to the biasing of the spring 49.

At the opening position, the plug hole 40 and the analysis chamber 28 do not communicate with each other through the bypass pipe 43, and the plug hole 40 is opened to the space in the atmospheric pressure environment. When blackout occurs, the first pore 7 is at an intermediate pressure between the ion source container 9 and the first differential evacuation chamber 16. On the other hand, air 50 flows from the space in the atmospheric pressure environment into the plug hole 40. Therefore, a portion of the plug hole 40 below the sealing plug 41 has a low vacuum degree close to the atmospheric pressure, and a portion of the plug hole 40 above the sealing plug 41 has a pressure close to the atmospheric pressure.

When the valve element 45 is switched to the opening position, a large pressure difference is not applied to both sides of the sealing plug 41. Therefore, the sealing plug 41 falls due to its own weight to close the first pore 7. Next, when power feeding to the analyzer 100 restarts, power is applied to the solenoid coil 47, and thus the first pore 7 opens again. When the vacuum pump 18, 22 restarts, the analysis using the analyzer 100 can restart.

With the pressure type sealing plug 41, when power feeding to the analyzer 100 stops and power application to the vacuum pump 18, 22 stops, power application to the solenoid coil 47 also stops. Therefore, the first pore 7 can be closed without power. Since the first pore 7 is closed, the inflow of gas into the aspiration side of the vacuum pump 18, 22 can be prevented. When the sealing plug 41 penetrates into the first pore 7 without completely closing the first pore 7, the inflow rate of gas can be reduced to be lower than an allowable inflow rate when the turbomolecular pump 22 slows down. Therefore, a load on the blade of the vacuum pump 18, 22 can be reduced, and the vacuum pump 18, 22 can be protected.

In FIGS. 1, 2A, and 2B, the sealing plug 41 is configured to operate due to a pressure difference between the ion source container 9 and the analysis chamber 28. The analysis chamber 28 is a space that is maintained at the maximum vacuum degree in the vacuum chamber 16, 19, 28. Therefore, when the bypass pipe 43 connects the plug hole 40 and the analysis chamber 28 to each other, the sealing plug 41 can easily float due to the pressure difference.

It should be noted that, as long as a pressure difference required for the operation is ensured, the sealing plug 41 may be configured to operate due to a pressure difference between the ion source container 9 and the second differential evacuation chamber 19, or may be configured to operate due to a pressure difference between the ion source container 9 and the first differential evacuation chamber 16. The bypass pipe 43 may connect the plug hole 40 and the second differential evacuation chamber 19 or connect the plug hole 40 and the first differential evacuation chamber 16 to each other instead of the plug hole 40 and the analysis chamber 28.

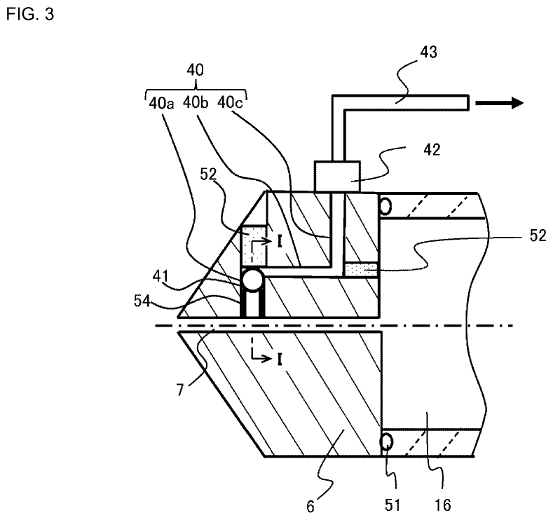

FIG. 3 is a diagram illustrating a method of forming the plug hole in the analyzer.

As illustrated in FIG. 3, the plug hole 40 can be formed by drilling the iontophoresis electrode 6. By combining a linear through hole with the plug hole 40, the sections 40a, 40b, and 40c that communicate with each other at the bent portion can be formed.

In the iontophoresis electrode 6, a through hole corresponding to the section 40a that extends upward from the intermediate portion of e first pore 7, a through hole corresponding to the section 40b that extends in the horizontal direction at an intermediate height, and a through hole corresponding to the section 40c that extends upward from the intermediate height are formed by turning. The sealing plug 41 is inserted into the section 40a extending upward from the intermediate portion of the first pore 7. When a closing member 52 is pressed into each of the through holes, the plug hole 40 is formed.

As the closing member 52, an appropriate material such as carbon steel or stainless steel can be used as long as heat resistance to a high temperature of about 200° C. and the strength that can endure press fitting can be ensured. The iontophoresis electrode 6 can be formed of, for example, stainless steel. The iontophoresis electrode 6 and the first differential evacuation chamber 16 are airtightly sealed by an O-ring 51.

The sealing plug 41 can be formed of metal such as carbon steel or stainless steel or ceramic such as silicon nitride. As long as the inflow rate of gas through the first pore 7 can be reduced to be lower than an allowable inflow rate when the vacuum pump 18, 22 slows down, the sealing plug 41 can be provided in an appropriate shape such as a spherical shape, a cylindrical shape, or a spindle shape. It should be noted that the sealing plug 41 needs to be provided in consideration of the weight of the sealing plug 41, a buoyancy force that is generated by the pressure difference formed through the bypass pipe 43, a frictional force with the inner wall of the plug hole 40, and the like.

For example, a gravity F1 action on the sealing plug 41 is represented by F1 ≈0.032 gf assuming that the sealing plug 41 is a sphere formed of carbon steel having a diameter ϕ=2 mm. A buoyancy force F2 action on the sealing plug 41 is represented by F2 ≈15.7 gf assuming that the vacuum degree of the lower portion of the sealing plug 41 during blackout is half of the atmospheric pressure. A frictional force F3 action on the sealing plug 41 is represented by F3 ≈0.016 gf assuming that a frictional coefficient μ between the sealing plug 41 and the inner wall of the plug hole 40 is 0.5. It is known that the frictional coefficient μ increases even due to contact between different metals in a high vacuum degree.

Under this condition, F1+F3 (≈0.048 gf)<<F2 (≈15.7 gf). The sealing plug 41 can be provided such that the sealing plug 41 floats due to a pressure difference between the first pore 7 and the analysis chamber 28 during blackout at the assumed frictional coefficient μ with the inner wall of the plug hole 40 and falls due to its own weight and a pressure difference between the first pore 7 and the atmospheric pressure during blackout.

A small clearance may be formed between the sealing plug 41 and the inner wall of the plug hole 40. When the clearance is formed, gas flows out from the first pore 7 to the analysis chamber 28. However, when a clearance of about 10 μm or less is present between the sealing plug 41 and the inner wall of the plug hole 40, the outflow amount of gas can be reduced to be negligible. When the clearance is about 10 μm or less, the sealing plug 41 can float due to a pressure difference during power feeding to the analyzer 100.

For example, when the plug hole 40 is formed with a diameter ϕ=2 mm and a tolerance class F8 (tolerance: 0.006 to 0.020 mm) and a precise carbon steel ball (tolerance: 0 to 0.005 mm) having a diameter ϕ=2 mm is used as the sealing plug 41, a maximum clearance is 20 μm and an average clearance is about 10.5 μm (13 μm−2.5 μm).

A thermal expansion coefficient of carbon steel is about 12×10⁻⁶/K. A thermal expansion coefficient of stainless steel is about 17×10⁻⁶/K. When the iontophoresis electrode 6 is heated to 200° C., the hole diameter of the plug hole 40 is more than the diameter of the carbon steel ball by about 1.8 μm as compared to that at 20° C. that is normal temperature. A difference between the hole diameter of the plug hole 40 and the diameter of the sealing plug 41 during thermal expansion is less than that at normal temperature. The average clearance during thermal expansion is about 12.3 μm (10.5 μm+1.8 μm). A ratio between the average clearance thermal expansion and the hole diameter of the plug hole 40 is about 163:1, and the clearance ratio can be sufficiently reduced.

It is preferable that an opening on the first pore 7 side of the plug hole 40 is provided on the upstream side where the ion source container 9 is present in the intermediate portion of the first pore 7. For example, unless there is a problem in processing or interference with a gas flow path or the like, it is preferable that an opening on the first pore 7 side of the plug hole 40 is provided upstream of the iontophoresis electrode 6 provided in a conical shape. The pressure of the first pore 7 approaches the atmospheric pressure toward the upstream side where the ion source container 9 is present. On the other hand, the vacuum degree increases toward the downstream side where the first differential evacuation chamber 16 is present. The pressure difference formed through the bypass pipe 43 increases as the position of the plug hole 40 approaches the upstream side of the first pore 7, and thus the buoyancy force of the sealing plug 41 is easily ensured.

The sealing plug 41 and the iontophoresis electrode 6 can also be formed of the same metal such as stainless steel. When the hole diameter of the plug hole 40 increases during thermal expansion, gas may flow out from a clearance between the plug hole 40 and the sealing plug 41. However, when the sealing plug 41 and the iontophoresis electrode 6 are formed of the same material, a difference in thermal elongation is reduced, and leakage of the gas can be prevented. It should be noted that, when the sealing plug 41 and the iontophoresis electrode 6 are formed of the same metal, the frictional coefficient μ increases, and thus it is preferable to perform lubrication.

As necessary, a liquid lubricant may be applied to or a solid lubricant may be formed on the inner wall of the plug hole 40 in contact with the sealing plug 41. As the liquid lubricant, a kind having a low vapor pressure is preferable. As the liquid lubricant, perfluoropolyether such as FOMBLIN, a fluorine-based lubricant such as polytetrafluoroethylene, or the like can be used. As the solid lubricant, molybdenum disulfide, tungsten disulfide, boron nitride, boric acid, polytetrafluoroethylene, chromium, silver, a lead alloy, or the like can be used. The solid lubricant can be formed by sputtering, ion plating, plating, or the like.

As necessary, mirror finishing for reducing the surface roughness may be performed on the inner wall of the plug hole 40 in contact with the sealing plug 41. For example, mechanical polishing, electrolytic polishing, chemical polishing, or the like can be performed on the inner wall of the plug hole 40. When the surface roughness of the inner wall of the plug hole 40 is reduced, the frictional coefficient μ with the sealing plug 41 is reduced, contamination is not likely to be attached, and carry-over is reduced.

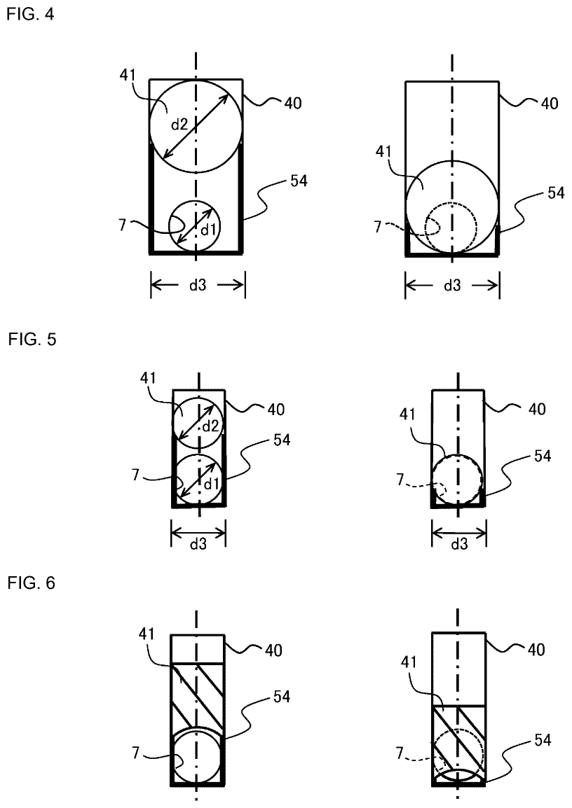

FIGS. 4, 5, and 6 are diagrams illustrating a structure example of the plug hole in the analyzer. FIGS. 4, 5, and 6 correspond to an I-I line cross-sectional view of FIG. 3.

In FIGS. 4 and 5, reference numeral d1 represents the hole diameter of the first pore 7, reference numeral d2 represents the diameter of the sealing plug 41, and reference numeral d3 represents the hole diameter of the plug hole 40. In FIGS. 4, 5, and 6, the left drawing illustrates a state where the sealing plug 41 floats, and the right drawing illustrates a state where the sealing plug 41 falls.

As illustrated in FIG. 4, the diagram d2 of the sealing plug 41 can be set to be more than the hole diameter d1 of the first pore 7. That is, the hole diameter d3 of the plug hole 40 can be set to be more than the hole diameter dl of the first pore 7. In addition, the height of a lower end of the sealing plug 41 can be set to be higher than the height of an upper end of the first pore 7 in a state where the sealing plug 41 floats.

The plug hole 40 can form a stepwise wall around the first pore 7 in a traveling direction of the ions or the like transmitting through the first pore 7. In a portion where the plug hole 40 and the first pore 7 are connected, the flow of the ions or the like is likely to remain. In this location, foreign matter 54 is likely to be attached to the inner wall of the plug hole 40. The foreign matter 54 may be the ions 4 that are ionized from the sample or may be neutral particles or the like other than ions.

The foreign matter 54 varies depending on the sample solution 1 or depending on the ions of the analysis target, and causes cross contamination. The foreign matter 54 peels off from the inner wall of the plug hole 40 when the sealing plug 41 operates to scrub. The peeled foreign matter 54 arrives at the detection unit to become noise of the mass spectrum, which may deteriorate the analysis accuracy. In the portion below the sealing plug 41, the amount of the foreign matter 54 attached increases as the surface area of the inner wall of the plug hole 40 increases.

Therefore, as illustrated in FIG. 5, it is preferable that the diagram d2 of the sealing plug 41 is set to be slightly more than the hole diameter d1 of the first pore 7. That is, it is preferable that the hole diameter d3 of the plug hole 40 is set to be slightly more than the hole diameter d1 of the first pore 7. For example, a difference between the diameter d2 of the sealing plug 41 and the hole diameter d1 of the first pore 7 is preferably 1 mm or less, more preferably 500 μm or less, and still more preferably 100 μm or less. It is preferable that the diameter d2 of the sealing plug 41 is a length where the sealing plug 41 does not penetrate into the first pore 7 at normal temperature during thermal expansion.

In addition, it is preferable that the height of the lower end of the sealing plug 41 is close to the height of the upper end of the first pore 7 in a state where the sealing plug 41 floats. For example, a difference between the height of the lower end of the sealing plug 41 and the height of the upper end of the first pore 7 is preferably 5 mm or less and more preferably 1 mm or less.

In this structure, the amount of the foreign matter 54 attached to the inner wall of the plug hole 40 can be reduced. Therefore, a high analysis accuracy can be ensured. Even when the sealing plug 41 operates, a large amount of the foreign matter 54 does not peel off from the inner wall of the plug hole 40. Not only at the time of analysis restart after blackout but also in a state where power is fed to the analyzer 100, carry-over can be reduced.

As illustrated in FIG. 6, the sealing plug 41 can also be provided in a shape where a lower surface of the sealing plug 41 and an upper surface of the first pore 7 are substantially flush with each other in a floating state. In FIG. 6, the sealing plug 41 is provided in a cylindrical shape where the lower portion is cut out in a recessed shape. The lower portion of the sealing plug 41 is cut out in an arc shape at the same curvature as that of the first pore 7 in a cross-sectional view.

In this structure, in a state where the sealing plug 41 floats, the amount of the foreign matter 54 attached to the inner wall of the plug hole 40 can be reduced. When blackout occurs, the first pore 7 cannot be completely blocked. However, the inflow of gas can be reduced to the extent that the breakage of the turbomolecular pump 22 can be prevented. In this structure, a counterbore may or may not be provided in the bottom portion of the plug hole 40. From the viewpoint of reducing the remaining of the flow of the ions or the like, it is preferable that the counterbore is not provided.

In FIGS. 4, 5, and 6, the bottom portion of the plug hole 40 has a rectangular shape. However, the bottom portion of the plug hole 40 can also be matched to the bottom surface of the first pore 7. When analysis restarts after blackout, as long as a buoyancy force action on the fallen sealing plug 41 can be ensured, a structure where the sealing plug 41 is landed on the bottom surface of the first pore 7 can also be provided.

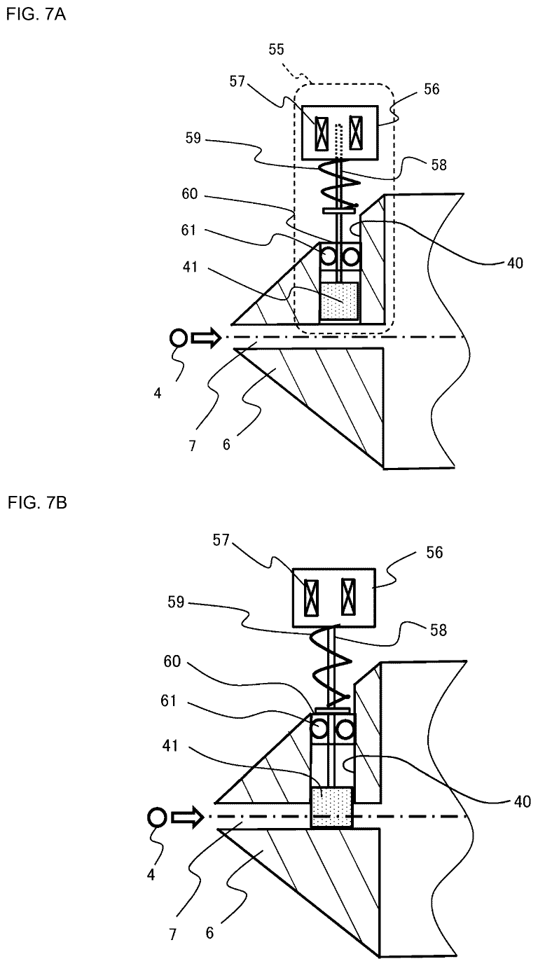

FIGS. 7A and 7B are diagrams illustrating an operation of an electromagnetic sealing plug in the analyzer. FIG. 7A illustrates a state of the vacuum pump 18, 22 during power application when power is fed to the analyzer 100. FIG. 7B illustrates a state of the vacuum pump 18, 22 during blackout when power feeding to the analyzer 100 stops.

As illustrated in FIGS. 7A and 7B, as the sealing plug 41 in the analyzer 100, an electromagnetic type that is driven by an electromagnetic actuator 55 can also be provided.

In FIGS. 7A and 7B, in the iontophoresis electrode 6, the plug hole 40 having a straight hole shape is connected to the first pore 7. One end of the plug hole 40 is opened to the intermediate portion of the first pore 7. Another end of the plug hole 40 is opened to the upper portion of the iontophoresis electrode 6. The sealing plug 41 supported by the electromagnetic actuator 55 is inserted into the plug hole 40 having a straight hole shape.

The electromagnetic actuator 55 has a function of closing the first pore 7 with the sealing plug 41 by stopping power application during blackout. The electromagnetic actuator 55 includes a coil housing 56, a solenoid coil 57, a movable magnetic member 58, a spring 59, a shaft seal member 60, and an O-ring 61.

The sealing plug 41 is fixed to one end of the movable magnetic member 58. The sealing plug 41 supported by the electromagnetic actuator 55 can be provided in an appropriate shape such as a spherical shape, a cylindrical shape, or a spindle shape. The coil housing 56 accommodates the solenoid coil 57. The solenoid coil 57 is connected to a power supply (not illustrated), and generates an electromagnetic force by power application.

The movable magnetic member 58 has magnetism and is movable by the electromagnetic force. A tip of the movable magnetic member 58 is inserted into the plug hole 40 and supports the sealing plug 41. A base of the movable magnetic member 48 is inserted into the solenoid coil 57 to advance to and retreat from the inside of the solenoid coil 57. The spring 59 elastically links the coil housing 56 and the movable magnetic member 58 to each other. The spring 59 biases the movable magnetic member 58 toward the first pore 7 side such that the reaction force to the electromagnetic force is applied to the movable magnetic member 58.

The shaft seal member 60 includes an opening in the upper portion of the plug hole 40. The shaft seal member 60 seals the plug hole 40 into which the movable magnetic member 58 is inserted in a state where the movable magnetic member 58 can advance and retreat. The O-ring 61 is accommodated in the shaft seal member 60. The O-ring 61 airtightly seals a slide portion with the movable magnetic member 58. The shaft seal member 60 or the O-ring 61 prevents leakage of gas through the plug hole 40.

When power application to the vacuum pump 18, 22 is stopped during blackout, the sealing plug 41 supported by the electromagnetic actuator 55 closes the first pore 7. On the other hand, when power is applied to the vacuum pump 18, 22, the sealing plug 41 supported by the electromagnetic actuator 55 is pulled up from the first pore 7 into the plug hole 40 due to the electromagnetic force of the electromagnetic actuator 55 to open the first pore 7.

As illustrated in FIG. 7A, when power is fed to the analyzer 100, power is applied to the solenoid coil 57. The solenoid coil 57 generates an electromagnetic force by power application, and aspirates and pulls up the movable magnetic member 58 with the electromagnetic force. The sealing plug 41 supported by the movable magnetic member 58 is pulled up from the first pore 7, is held in the plug hole 40, and opens the first pore 7.

On the other hand, as illustrated in FIG. 7B, when power feeding to the analyzer 100 stops, power application to the solenoid coil 57 stops. The solenoid coil 57 does not generate an electromagnetic force and does not pull up the movable magnetic member 58. The sealing plug 41 supported by the movable magnetic member 58 penetrates into the first pore 7 from the plug hole 40 and closes the first pore 7 according to the repulsive force of the spring 59 applied to the movable magnetic member 58.

When the iontophoresis electrode 6 is heated to a high temperature, it is preferable that the electromagnetic actuator 55 has heat resistance. As the heat-resistant O-ring 61, perfluoropolyether rubber such as VITON or an fluorine-based elastomer such as polyvinylidene fluoride copolymer rubber can be used. In addition, it is preferable that the movable magnetic member 58, an adjacent portion to the movable magnetic member 58 and the coil housing 56, or a joined portion of the movable magnetic member 58 and the spring 59 has a highly heat-resistant structure. For example, a heat-resistant material having a high thermal conductivity such as ceramic or a heat-resistant resin can be provided in an intermediate portion of the movable magnetic member 58, between the movable magnetic member 58 and the coil housing 56, or between the movable magnetic member 58 and the spring 59.

With the electromagnetic sealing plug 41, when power feeding to the analyzer 100 stops and power application to the vacuum pump 18, 22 stops, power application to the solenoid coil 57 also stops. Therefore, the first pore 7 can be closed without power. Since the first pore 7 is closed, the inflow of gas into the aspiration side of the vacuum pump 18, 22 can be prevented. The electromagnetic sealing plug 41 is limited in the disposition or the structure of the electromagnetic actuator 55 as compared to the pressure type sealing plug 41. However, the degree of freedom for designing the sealing plug 41 or the plug hole 40 increases.

Hereinabove, the embodiment of the present invention have been described, but the present invention is not limited to the above-described embodiment. Within a range not departing from the scope of the present invention, various changes can be made. For example, the present invention does not need to include all the configurations in the embodiment. A part of configurations in one embodiment may be replaced with other configurations, a part of configurations in one embodiment may be added to another embodiment, or a part of configurations in one embodiment may be omitted.

For example, the above-described analyzer 100 is a mass spectrometer. However, the analyzer including the sealing plug that can seal a pore through which charged particles are introduced into the vacuum chamber from the charged particle generation source is applicable to other analyzers as long as it includes a charged particle generation source that generates charged particles, a vacuum chamber of which an inside is evacuated, a pore through which the charged particles are introduced into the vacuum chamber from the charged particle generation source, a vacuum pump that is connected to the vacuum chamber. Examples of the other analyzer include a scanning electron microscope (SEM), a transmission electron microscope (TEM), and a focused ion beam (FIB) device.

### Reference Signs List

100: analyzer
2: ion source (charged particle generation source)
6: iontophoresis electrode
7: first pore 7 (pore)
9: ion source container
11: ion guide
15: first porous electrode
16: first differential evacuation chamber (vacuum chamber)
17: ion thermalizer
18: dry pump (vacuum pump)
19: second differential evacuation chamber (vacuum chamber)
20: second porous electrode
22: turbomolecular pump (vacuum pump)
24: mass filter
25: first mass filter
26: collision chamber
27: second mass filter
28: analysis chamber (vacuum chamber)
30: conversion dynode
31: scintillator
32: photomultiplier tube
40: plug hole
41: sealing plug
42: vacuum joint
43: bypass pipe
44: vacuum valve
45: valve element
46: coil housing
47: solenoid coil
48: movable magnetic member
49: spring
50: air
51: O-ring
52: closing member
55: electromagnetic actuator
56: coil housing
57: solenoid coil
58: movable magnetic member
59: spring
60: shaft seal member
61: O-ring

1. An analyzer comprising:
a charged particle generation source that generates charged particles;
a vacuum chamber of which an inside is evacuated;
a pore through which the charged particles are introduced into the vacuum chamber from the charged particle generation source;
a vacuum pump that is connected to the vacuum chamber; and
a sealing plug that is capable of sealing the pore,
wherein when power application to the vacuum pump stops, the sealing plug seals the pore.

2. The analyzer according to claim 1,
wherein when power is applied to the vacuum pump, the sealing plug operates due to a pressure difference between the pore and the vacuum chamber to open the pore.

3. The analyzer according to claim 2, further comprising:
a plug hole that is connected to an intermediate portion of the pore; and
a bypass pipe that connects the plug hole and the vacuum chamber to each other,
wherein the sealing plug is held in the plug hole.

4. The analyzer according to claim 3, further comprising:
a valve that switches between connection of the plug hole and the vacuum chamber and connection of the plug hole and a space in an atmospheric pressure environment,
wherein when power application to the vacuum pump stops, the valve opens the connection of the plug hole and the space in the atmospheric pressure environment, and when power is applied to the vacuum pump, the valve opens the connection of the plug hole and the vacuum chamber.

5. The analyzer according to claim 4,
wherein the vacuum chamber is configured with a plurality of rooms that are differentially evacuated, and
the bypass pipe connects the plug hole and a room having a maximum vacuum degree in the vacuum chamber to each other.

6. The analyzer according to claim 1,
wherein when power is applied to the vacuum pump, the sealing plug operates due to an electromagnetic force to open the pore.

7. The analyzer according to claim 6,
a plug hole that is connected to an intermediate portion of the pore; and
an electromagnetic actuator that is provided in the plug hole,
wherein the sealing plug is supported in the electromagnetic actuator and is held in the plug hole.

8. The analyzer according to claim 1,
wherein the vacuum pump is a turbomolecular pump.
